(19) United States
(12) Patent Application Publication
(10) Pub. No.: US 2017/0075812 A1
(43) Pub. Date: Mar. 16, 2017

(54) TECHNOLOGIES FOR MANAGING A DYNAMIC READ CACHE OF A SOLID STATE DRIVE

(71) Applicant: Intel Corporation, Santa Clara, CA (US)

(72) Inventors: Ning Wu, Folsom, CA (US); Dale J. Juenemann, North Plains, OR (US); Neeraj Sharma, Folsom, CA (US); Ramkarthik Ganesan, Folsom, CA (US)

(21) Appl. No.: 14/855,660

(22) Filed: Sep. 16, 2015

(51) Int. Cl. G06F 12/08

(52) U.S. Cl. CPC G06F 12/0893; G06F 12/0891; G06F 2212/222

(57) ABSTRACT

Technologies for managing a read cache of a solid state drive include establishing a read cache in an otherwise unused region of non-volatile memory of the solid state drive. To do so, a memory region of the non-volatile memory corresponding to the read cache is converted to single-level cell (SLC) mode. For example, the memory region may be converted from a multi-level cell (MLC) or a triple-level cell (TLC) mode to the SLC mode. A drive controller of the solid state drive manages data in the read cache based on a read count associated with the data. For example, data having a relatively high read count may be inserted into the read cache and data having a relatively lower read count may be evicted from the read cache over time. The size of the read cache may be dynamically adjusted over time based on available space and/or operating requirements.

### BACKGROUND

Solid state drives (SSDs) are data storage devices that rely on memory integrated circuits to store data in a non-volatile or persistent manner. Unlike hard disk drives, solid state drives do not include moving, mechanical parts, such as a movable drive head and/or drive spindle. As such, solid state drives are generally more durable to physical contact (e.g., bumping) during operation and operate more quietly than traditional disk drives. Due to the reliance on solid state memory devices to store data, solid state drives generally exhibit lower access time relative to typical disk drives.

A typical solid state drive may include a large amount of non-volatile memory, which is oftentimes based on NAND flash memory technology, although NOR flash memory may be used in some implementations. The majority of data stored on a solid state drive is stored in the non-volatile memory for long-term storage. To reduce the overall cost and footprint of solid state drives, many solid state drives utilize larger die memory storage devices (e.g., large NAND chips) in a multi-level cell (MLC) or triple-level cell (TLC) mode, which allows multiple bits of data to be stored in a single memory cell. However, the increase in the die size of the memory storage devices and usage of the multi-bit storage technology can decrease the parallelism inherent in multiple memory storage device architecture and can result in slower access time, especially during a read cycle, due to an increased need for data error checking.

### BRIEF DESCRIPTION OF THE DRAWINGS

The concepts described herein are illustrated by way of example and not by way of limitation in the accompanying figures. For simplicity and clarity of illustration, elements illustrated in the figures are not necessarily drawn to scale. Where considered appropriate, reference labels have been repeated among the figures to indicate corresponding or analogous elements.

FIG. 1 is a simplified block diagram of at least one embodiment of a solid state drive configured to manage a dynamic read cache of a non-volatile memory of the solid state drive;

FIG. 2 is a simplified block diagram of a non-volatile memory of a typical solid state drive having two different regions with different performance and endurance characteristics;

FIG. 3 is a simplified block diagram of at least one embodiment of the non-volatile memory the solid state drive of FIG. 1 at a usage capacity;

FIG. 4 is a simplified block diagram of at least one embodiment of the non-volatile memory the solid state drive of FIG. 1 at another usage capacity;

FIG. 5 is a simplified block diagram of at least one embodiment of the non-volatile memory the solid state drive of FIG. 1 at another usage capacity;

FIG. 6 is a simplified block diagram of at least one embodiment of a computing system including the solid state drive of FIG. 1;

FIG. 7 is a simplified block diagram of at least one embodiment of an environment that may be established by the solid state drive of FIG. 1;

FIG. 8 is a simplified flow diagram of at least one embodiment of a method for initializing a non-volatile memory of the solid state drive that may be executed by a drive controller of the solid state drive of FIGS. 1 and 7;

FIG. 9 is a simplified flow diagram of at least one embodiment of a method for managing a memory access request that may be executed by the drive controller of the drive controller of the solid state drive of FIGS. 1 and 7;

FIG. 10 is a simplified flow diagram of at least one embodiment of a method for inserting data into a read cache of the non-volatile memory of the solid state drive that may be executed by the drive controller of the solid state drive of FIGS. 1 and 7;

FIG. 11 is a simplified block diagram of at least one embodiment of a memory context table that may be managed by the drive controller of the solid state drive of FIGS. 1 and 7; and

FIG. 12 is a simplified flow diagram of at least one embodiment of a method for managing evicting data from the read cache of the non-volatile memory of the solid state drive that may be executed by the drive controller of the solid state drive of FIGS. 1 and 7.

### DETAILED DESCRIPTION OF THE DRAWINGS

While the concepts of the present disclosure are susceptible to various modifications and alternative forms, specific embodiments thereof have been shown by way of example in the drawings and will be described herein in detail. It should be understood, however, that there is no intent to limit the concepts of the present disclosure to the particular forms disclosed, but on the contrary, the intention is to cover all modifications, equivalents, and alternatives consistent with the present disclosure and the appended claims.

References in the specification to “one embodiment,” “an embodiment,” “an illustrative embodiment,” etc., indicate that the embodiment described may include a particular feature, structure, or characteristic, but every embodiment may or may not necessarily include that particular feature, structure, or characteristic. Moreover, such phrases are not necessarily referring to the same embodiment. Further, when a particular feature, structure, or characteristic is described in connection with an embodiment, it is submitted that it is within the knowledge of one skilled in the art to effect such feature, structure, or characteristic in connection with other embodiments whether or not explicitly described. Additionally, it should be appreciated that items included in a list in the form of “at least one A, B, and C” can mean (A); (B); (C); (A and B); (A and C); (B and C); or (A, B, and C). Similarly, items listed in the form of “at least one of A, B, or C” can mean (A); (B); (C); (A and B); (A and C); (B and C); or (A, B, and C).

The disclosed embodiments may be implemented, in some cases, in hardware, firmware, software, or any combination thereof. The disclosed embodiments may also be implemented as instructions carried by or stored on a transitory or non-transitory machine-readable (e.g., computer-readable) storage medium, which may be read and executed by one or more processors. A machine-readable storage medium may be embodied as any storage device, mechanism, or other physical structure for storing or transmitting information in a form readable by a machine (e.g., a volatile or non-volatile memory, a media disc, or other media device).

In the drawings, some structural or method features may be shown in specific arrangements and/or orderings. However, it should be appreciated that such specific arrangements and/or orderings may not be required. Rather, in some embodiments, such features may be arranged in a different manner and/or order than shown in the illustrative figures. Additionally, the inclusion of a structural or method feature in a particular figure is not meant to imply that such feature is required in all embodiments and, in some embodiments, may not be included or may be combined with other features.

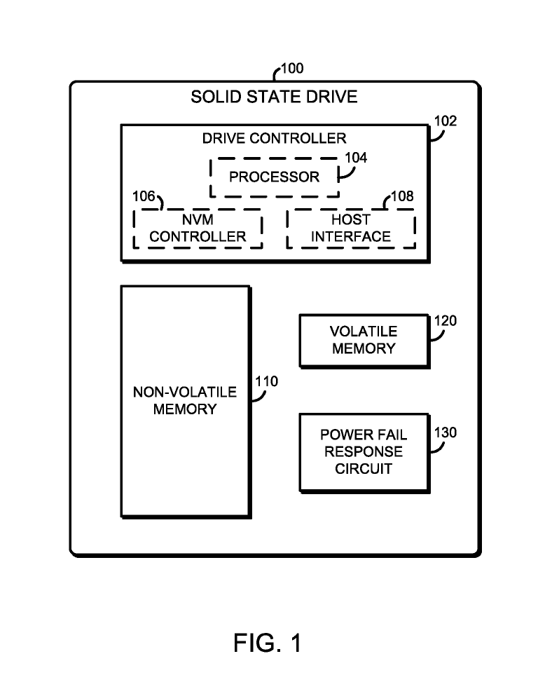

Referring now to FIG. 1, an illustrative solid state drive 100 includes a drive controller 102 and a non-volatile memory 110. As discussed in more detail below, the drive controller 102 is configured to establish and manage a read cache in the non-volatile memory 110 to improve read access speed of the solid state drive 100. To do so, the drive controller 102 converts an otherwise empty memory region of the non-volatile memory 110 corresponding to the read cache to a single-level cell (SLC) mode, which exhibits improved access speed at the cost of reduced storage density. A user data region of the non-volatile memory 110, which is used to store user data, is maintained in a multi-level cell (MLC) mode or triple-level cell (TLC) mode to increase the overall storage capacity of the non-volatile memory 110. The non-volatile memory 110 also includes a write buffer to improve write access timing of the solid state drive 100, which is also maintained in a SLC mode.

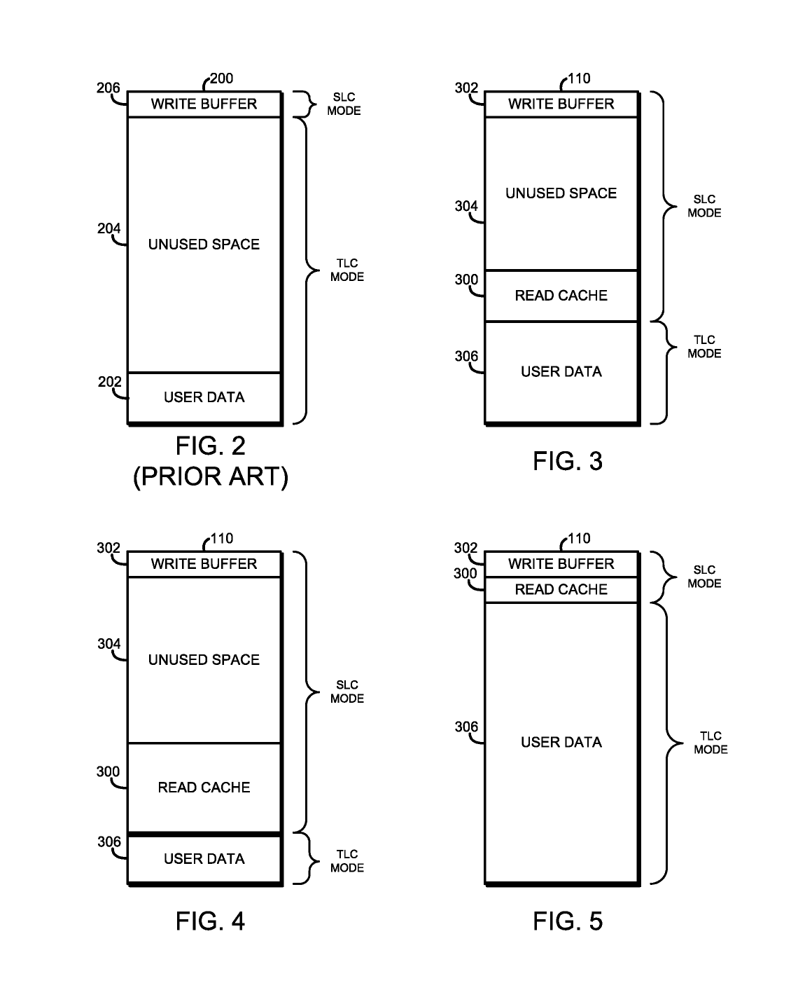

During operation of the solid state drive 100, the drive controller 102 may dynamically increase or decrease the size of the read cache of the non-volatile memory 110 based on one or more criteria by converting memory regions of the non-volatile memory 110 to SLC mode or back to MLC or TLC mode. For example, a typical non-volatile memory 200 of a solid state drive is shown in FIG. 2. The typical non-volatile memory 200 includes a user data region 202 for storing user data, an unused memory space 204, and a write buffer 206. As shown in FIG. 2, the user data region 202 and unused space 204 are maintained in TLC mode, while the write buffer 206 may be maintained in SLC mode in some solid state drives. However, unlike the typical non-volatile memory 200, the illustrative non-volatile memory 110 of the solid state drive 100 includes a read cache 300 for storage of user data having a relatively high read count (i.e., user data that is read often) as shown in FIG. 3. The non-volatile memory 110 also includes a write buffer 302 for storage of new data written to the non-volatile memory 110, unused space 304, and a user data region 306 for storage of user data in long term storage. As shown in FIG. 3, the read cache 300, write buffer 302, and the unused memory space 304 are maintained in SLC mode, although the unused memory space 304 may be maintained in TLC or MLC mode in other embodiments.

The present size of the read cache 300 is based on the available amount of unused space 304 and/or the size of the user data region 306 in the illustrative embodiment. For example, as shown in FIG. 4, as the amount of unused memory space 304 increases and the size of the user data region 306 decreases, the drive controller 102 may increase the size of the read cache 300 by converting memory regions of the non-volatile memory 110 to SLC mode and migrating user data into the newly created regions of the read cache. Conversely, as shown in FIG. 5, as the amount of unused memory space 304 decreases and the size of the user data region 306 increase, the drive controller 102 may decrease the size of the read cache 300 by converting memory regions of the non-volatile memory 110 corresponding to the read cache 300 from the SLC mode to the TLC or MLC mode. Additionally, because the memory regions of the read cache 300 may be converted back to TLC or MLC mode from the SLC mode as the solid state drive 100 fills with data, the read cache 300 is managed by the drive controller 102 for lower TLC or MLC endurance (e.g., by applying TLC or MLC wear leveling procedures for write cycles).

Referring back to FIG. 1, the drive controller 102 of the solid state drive 100 may be embodied as any type of control device, circuitry, or collection of hardware devices capable of controlling operation of the solid state drive 100 and performing the functions described herein. In the illustrative embodiment, the drive controller 102 includes a processor or processing circuitry 104, a non-volatile memory controller 106, and a host interface 108. Of course, the drive controller 102 may include additional devices, circuits, and/or components commonly found in a drive controller of a solid state drive in other embodiments.

The processor 104 may be embodied as any type of hardware processor or processing circuitry capable of performing the functions described herein. For example, the processor 104 may be embodied as a single or multi-core processor(s), digital signal processor, microcontroller, or other processor or processing/controlling circuit. In the illustrative embodiment, the processor 104 controls and manages operation of other components of the drive controller 102.

Similar to the processor 104, the non-volatile memory controller 106 may be embodied as any type of hardware processor, processing circuitry, or collection of devices capable of managing the non-volatile memory 110. In use, the non-volatile memory controller 106 manages read and write access to the non-volatile memory 110. Additionally, the non-volatile memory controller 106 may manage various metadata associated with the non-volatile memory 110 including, but not limited to, a logical-to-physical indirection table, a read count and write count associated with data stored in the non-volatile memory 110, a level of invalidation of regions of the non-volatile memory 110, and/or other metadata related to the data stored in the non-volatile memory 110.

In some embodiments, the processor 104 and the non-volatile memory controller 106 may be embodied as the same hardware processor, processing circuitry, and/or collection of devices. Additionally, in some embodiments, the processor 104 and the non-volatile memory controller 106 may form a portion of a System-on-a-Chip (SoC) and be incorporated, along with other components of the drive controller 102, onto a single integrated circuit chip.

The host interface 108 may also be embodied as any type of hardware processor, processing circuitry, input/output circuitry, and/or collection of components capable of facilitating communication of the solid state drive 100 with a host device or service (e.g., a host application). That is, the host interface 108 embodies or establishes an interface for accessing data stored on the solid state drive 100. To do so, the host interface 108 may be configured to utilize any suitable communication protocol and/or technology to facilitate communications with the solid state drive 100. For example, the host interface 108 may be configured to communicate with a host device or service using Serial Advanced Technology Attachment (SATA), Peripheral Component Interconnect express (PCIe), Serial Attached SCSI (SAS), Universal Serial Bus (USB), and/or other communication protocol and/or technology.

The non-volatile memory 110 may be embodied as any type of non-volatile memory capable of being managed in multiple speed and endurance levels and performing the functions described herein. For example, the non-volatile memory 110 may be embodied as NAND flash memory with single-level cell (SLC) mode capability in which each memory cell stores a single bit of information and either triple level cell (TLC) mode capability in which each memory cell stores three bits of information and/or multi-level cell (MLC) mode capability in which each memory cell stores two bits of information. In the illustrative embodiments, the non-volatile memory 110 is embodied as NAND flash memory, but other types of non-volatile memory may be used in other embodiments. The non-volatile memory 110 may be formed from multiple, discrete memory devices (e.g., multiple NAND circuit chips or dies), which may be managed and accessed by the non-volatile memory controller 106 in a parallel manner to increase the memory access speed of the solid state drive 100. In such embodiments, a memory band of physical memory may stretch across multiple, discrete memory devices. Additionally, virtual memory blocks may be located on multiple, discrete memory devices of the non-volatile memory 110.

In the illustrative embodiment, the solid state drive 100 also includes a volatile memory 120. The volatile memory 120 may be embodied as any type of volatile memory capable of storing data while the solid state drive 100 is operational. In the illustrative embodiment, the volatile memory 120 is embodied as dynamic random access memory (DRAM) ssuch as LPDDR3 (low power dual data rate version 3, original release by JEDEC (Joint Electronic Device Engineering Council) JESD209-3B, August 2013 by JEDEC), LPDDR4 (LOW POWER DOUBLE DATA RATE (LPDDR) version 4, JESD209-4, originally published by JEDEC in August 2014, or other types of DRAMS. In particular embodiments, the DRAM complies with a standard promulgated by the Joint Electron Device Engineering Council (JEDEC), such as JESD79F for DDR Double Data Rate (DDR) SDRAM, JESD79-2F for DDR2 SDRAM, JESD79-3F for DDR3 SDRAM, or JESD79-4A for DDR4 SDRAM (these standards are available at www.jedec.org). Of course, in other embodiments, other types of volatile memory in the other embodiments.

Illustratively, the volatile memory 120 is much smaller than the non-volatile memory 110 and is used during operation of the solid state drive 100 to store various metadata associated with the data stored in the non-volatile memory 110 such as a logical-to-physical indirection table and a memory context table, which identifies the read count, write count, and invalidation level of the data stored in the non-volatile memory 110 as discussed below. Of course, additional and/or other data may be stored in the volatile memory 120 in other embodiments. Due to the type of memory of the volatile memory 120 (e.g., DRAM memory), memory accesses to the volatile memory 120 may be faster than those to the non-volatile memory 110. In some embodiments, the solid state drive 100 may not include the volatile memory 120 and, in such embodiments, the meta-data associated with the data stored in the non-volatile memory 110 may instead be stored in the non-volatile memory 110.

In some embodiments, the solid state drive 100 may also include a power fail response circuit 130. The power fail response circuit 130 is configured to provide backup power to certain components of the solid state drive 100 for a period of time in the event that power to the solid state drive 100 is unexpectedly lost. The supply of backup power allows the solid state drive to copy data (e.g., the logical-to-physical indirection table, the memory context table, etc.) stored in the volatile memory 120 to the non-volatile memory 110 and/or perform other emergency procedures. To do so, the power fail response circuit 130 may include an amount of backup energy storage, such as a bank of capacitors of the like, to provide the backup power.

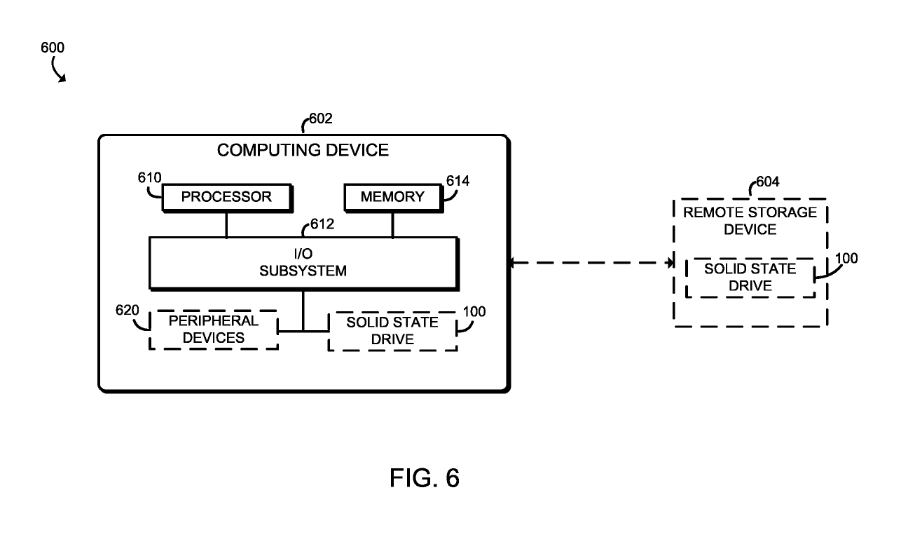

Referring now to FIG. 6, in some embodiments, the solid state drive 100 may form a portion of a computing system 600. For example, the solid state drive 100 may be incorporated into a computing device 602 and/or a remote storage device 604, which may be coupled to the computing device 602. The computing device 602 may be embodied as any type of computing device capable of communicating with the solid state drive 100 and/or the remote storage device 604 to access data stored on the solid state drive 100. For example, the computing device 602 may be embodied as a desktop computer, a mobile computing device, a notebook computer, a laptop computer, an enterprise computing system, a server, a server controller, a router, a switch, a smart appliance, a distributed computing system, a multiprocessor system, and/or any other computing device. As shown in FIG. 6, the illustrative computing device 602 includes a processor 610, an I/O subsystem 612, and memory 614. In some embodiments, the computing device 602 may include the solid state drive 100 as a component of the device 602. Additionally, the computing device 602 may include additional peripheral devices 620 in some embodiments. Of course, the computing device 602 may include other or additional components, such as those commonly found in a computer (e.g., various input/output devices), in other embodiments. Additionally, in some embodiments, one or more of the illustrative components may be incorporated in, or otherwise from a portion of, another component. For example, the memory 614, or portions thereof, may be incorporated in the processor 610 in some embodiments.

The processor 610 may be embodied as any type of processor capable of performing the functions described herein. For example, the processor 610 may be embodied as a single or multi-core processor(s), digital signal processor, microcontroller, or other processor or processing/controlling circuit. Similarly, the memory 614 may be embodied as any type of volatile or non-volatile memory or data storage capable of performing the functions described herein. The memory 614 is communicatively coupled to the processor 610 via the I/O subsystem 612, which may be embodied as circuitry and/or components to facilitate input/output operations with the processor 610, the memory 614, the solid state drive 100 (in embodiments in which the solid state drive 100 forms a portion of the computing device 602), and other components of the computing device 602. For example, the I/O subsystem 612 may be embodied as, or otherwise include, memory controller hubs, input/output control hubs, firmware devices, communication links (i.e., point-to-point links, bus links, wires, cables, light guides, printed circuit board traces, etc.) and/or other components and subsystems to facilitate the input/output operations.

The remote storage device 604 may be embodied as any type of data storage device remote capable of operating remotely from the computing device 602. For example, the remote storage device 604 may be embodied as a remote data server, remote computing device, and/or other electronic device capable of managing access requests to the local solid state drive 100. In some embodiments, for example, the remote storage device 604 may be embodied as a remote data server with which the computing device 602 communicates to access data stored on the solid state drive 100 of the remote storage device 604.

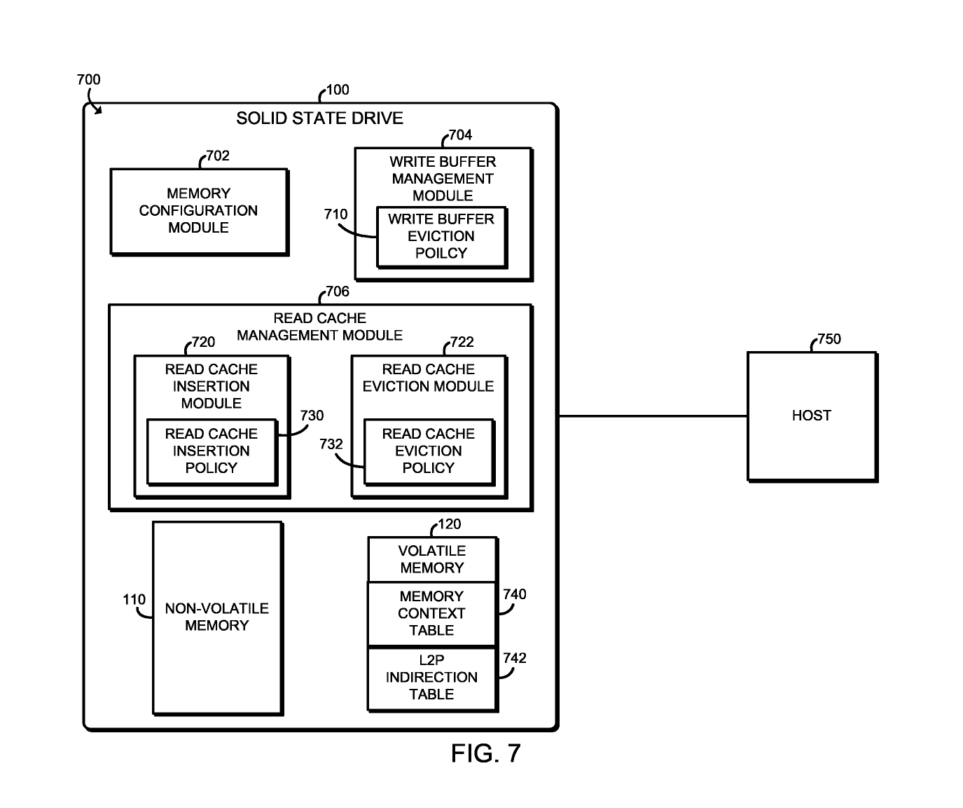

Referring now to FIG. 7, in use, the solid state drive 100 may establish an environment 700. The illustrative environment 700 includes a memory configuration module 702, a write buffer management module 704, and a read cache management module 706. Each of the modules and other components of the environment 700 may be embodied as firmware, software, hardware, or a combination thereof. For example the various modules, logic, and other components of the environment 700 may form a portion of, or otherwise be established by, the drive controller 102 other hardware components of the solid state drive 100. As such, in some embodiments, any one or more of the modules of the environment 700 may be embodied as a circuit or collection of electrical devices (e.g., a memory configuration circuit, a write buffer management circuit, a read cache management circuit, etc.).

The memory configuration module 702 is configured to initialize the non-volatile memory 110. For example, the memory configuration module 702 may be configured to establish the read cache 300 in the non-volatile memory 110 at a default size. To do so, as discussed above, the memory configuration module 702 may convert a region of the non-volatile memory 110 corresponding to the read cache 300 from TLC or MLC mode to SLC mode. The memory configuration module 702 may also establish the write buffer 302 in the non-volatile memory 110 in a similar manner.

The write buffer management module 704 is configured to manage operation of the write buffer 302 of the non-volatile memory 110 during operation. To do so, the write buffer management module 704 is configured to handle write access requests to the non-volatile memory 110 by storing new data associated with such requests to the write buffer 302. That is, all new data written to the illustrative solid state drive 100 is first stored in the write buffer 302. The write buffer management module 704 is also configured to update a write count associated with the written data and stored in a memory context table 740, which is stored in the volatile memory 120 during operation of the solid state drive 100.

Data written to the write buffer 302 remains in the write buffer 302 until the size of the write buffer reaches a reference threshold value. At such time, the write buffer management module 704 is configured to evict data from the write buffer to maintain the size of the write buffer 302 below the reference threshold value. The evicted data, which is controlled by a write buffer eviction policy 710, may be moved to the user data region 306 or the read cache 300, depending on a read count associated with the evicted data. For example, in the illustrative embodiment, the write buffer management module 704 may determine a read count and write count associated with the evicted data. If the ratio of the read count-to-write count is greater than a reference threshold value (or the write count-to-read count ratio is less than a reference threshold value), the write buffer management module 704 may move the evicted data to the read cache 300. Otherwise, the write buffer management module 704 is configured to move the evicted data to the user data region 306. The particular reference threshold used to determine when to evict data from the write buffer and where to move the evicted data may be stored in the write buffer eviction policy 710, which may be maintained by the write buffer management module 704.

Similar to the write buffer management module 704, the read cache management module 706 is configured to manage operation of the read cache 300 of the non-volatile memory 110 during operation. To do so, the read cache management module 706 is configured to handle read access requests to the non-volatile memory 110 by retrieving requested data from the non-volatile memory 110. As discussed above, data that is read often is stored in the read cache 300, but data may also be read from the user data region 306 and/or the write buffer 302 (e.g., if the data stored in the write buffer 302 is the freshest version of the requested data). If the received read request includes logical addressing of the requested memory location, the read cache management module 706 may identify the physical location of the requested data by accessing a logical-to-physical indirection table 742 stored in the volatile memory 120 during operation of the solid state drive 100. The read cache management module 706 is also configured to update a read count associated with the read data and stored in the memory context table 740.

To maintain the data of the read cache 300, the read cache management module 706 includes a read cache insertion module 720 and a read cache eviction module 722. The read cache insertion module 720 is configured to identify data for insertion into the read cache 300 based on a read count associated with the data. That is, the read cache insertion module 720 is configured to identify data having a relatively high read count (and corresponding low write count) for movement to the read cache 300. To do so, the read cache insertion module 720 may be configured to analyze the data in physical memory or in logical memory. For example, the read cache insertion module 720 may monitor a read count of a memory band in physical memory associated with the data and select the data for insertion to the read cache 300 if the read count is greater than, or otherwise satisfies, an insertion reference threshold value. The read cache insertion module 720 may also analyze the level of invalidation of the memory band in determining whether to move the data to the read cache 300. Additionally or alternatively, the read cache insertion module 720 may be configured to monitor a read count and a write count of a logical block addressed (LBA) range associated with the data to determine whether to move the data to the read cache 300. To do so, the read cache insertion module 720 may determine whether the read count-to-write count ratio of the identified data is greater than, or otherwise satisfies, an insertion reference threshold value. Of course, the read cache insertion module 720 may conversely analyze the write count-to-read count ratio to determine whether such ratio is below a reference threshold value. The particular reference threshold values used to identify the data to be inserted into the read cache 300 may be stored in a read cache insertion policy 730 managed by the read cache insertion module 720. If the read cache insertion module 720 determines that a particular piece of data satisfies the read cache insertion policy 730, the read cache insertion module 720 may move the data to the read cache 300.

The read cache eviction module 722 is configured to identify data currently stored in the read cache 300 for eviction therefrom based on a read count associated with the data. That is, the read cache eviction module 722 is configured to identify data having a relatively low read count (or corresponding high write count) for movement from the read cache 300. To do so, the read cache eviction module 722 may be configured to analyze the data in physical memory or in logical memory. For example, the read cache eviction module 722 may monitor a read count of a memory band in physical memory associated with the data and select the data for eviction from the read cache 300 if the read count is less than, or otherwise satisfies, an eviction reference threshold value. The read cache eviction module 722 may also analyze the level of invalidation of the memory band in determining whether to move the data from the read cache 300. Additionally or alternatively, the read cache eviction module 722 may be configured to monitor a read count and a write count of a logical block addressed (LBA) range associated with the data to determine whether to move the data from the read cache 300. To do so, the read cache eviction module 722 may determine whether the read count-to-write count ratio is less than, or otherwise satisfies, an eviction reference threshold value. Of course, the read cache eviction module 722 may conversely analyze the write count-to-read count ratio to determine whether such ratio is greater than a reference threshold value. The particular reference threshold values used to identify the data to be evicted from the read cache 300 may be stored in a read cache eviction policy 732 managed by the read cache eviction module 722. If the read cache eviction module 722 determines that a particular piece of data satisfies the read cache eviction policy 732, the read cache eviction module 722 may move the data from the read cache 300 to the user data region 306. Any incoming writes from the host 750 to a specific logical address will cause that logical address to be evicted by invaliding the previous copy in the read cache 300.

The write buffer management module 704 and/or read cache management module 706 are also configured to respond to memory access requests received from a host 750. The host 750 may be embodied as any type of device or service requesting a read or write access to non-volatile memory 110 of the solid state drive 100. For example, in some embodiments, the host 750 may be embodied as a software application executed by the computing device 602.

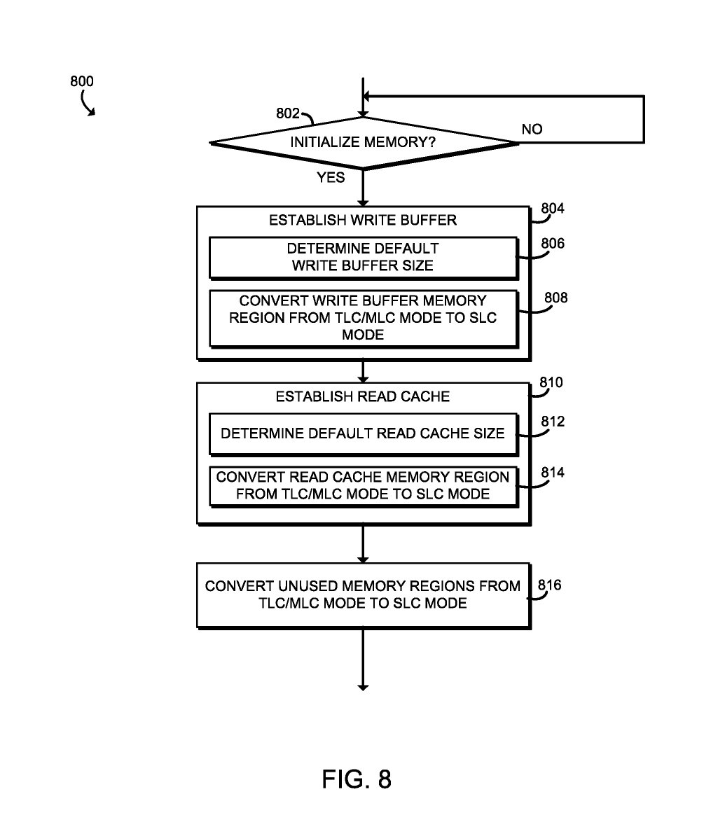

Referring now to FIG. 8, during operation, the drive controller 102 of the solid state drive 100 may execute a method 800 for initializing the non-volatile memory 110. The method 800 begins with block 802 in which the drive controller 102 determines whether to initialize the non-volatile memory 110. For example, such initialization may occur at the first power-up cycle of the solid state drive 100 or in response to a re-initialization (e.g., a re-formatting) instruction. If so, the method 800 advances to block 804 in which the drive controller 102 establishes the write buffer 302 in the non-volatile memory 110. To do so, the drive controller 102 may determine a size of the write buffer 302, which may be a default value, in block 806. Additionally, in block 808, the drive controller 102 may convert a memory region of the non-volatile memory 110 corresponding to the write buffer 302 from a TLC or MLC mode to the SLC mode in block 808.

In block 810, the drive controller 102 establishes the read cache 300 in the non-volatile memory 110. To do so, the drive controller 102 may determine a default or initial size of the read cache 300 in block 812. In some embodiments, the initial size of the read cache 300 may be a predetermined or hardcoded value or may be selectable or otherwise changeable during the initialization procedure. In block 814, similar to the write buffer 302, the drive controller 102 converts a memory region of the non-volatile memory 110 corresponding to the read cache 300 from a TLC or MLC mode to the SLC mode. As discussed above, memory regions of the non-volatile memory 110 configured in TLC or MLC may store multiple bits of data per memory cell, while those regions configured in SLC mode store a single bit of data per memory cell. However, access to memory regions configured in SLC mode may be faster than memory regions configured in TLC or MLC mode.

After the drive controller 102 has established the write buffer 302 and the read cache 300, the method 800 advances to block 816 in which the drive controller 102 converts the unused memory space 304 of the non-volatile memory 110 (i.e., memory regions other than the read cache 300, the write buffer 302, and the user data region 306) from TLC or MLC mode to the SLC mode. Alternatively, in some embodiments, the unused memory space 304 may remain in TLC or MLC mode and block 816 may be skipped.

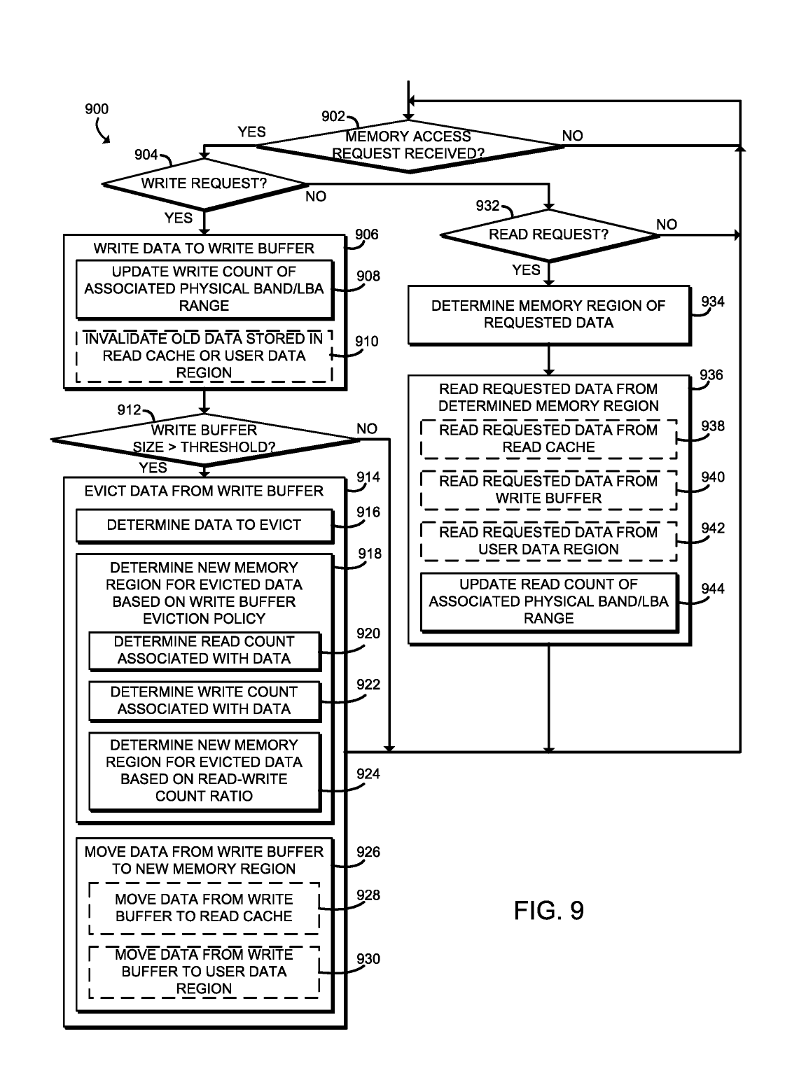

Referring now to FIG. 9, in use, the drive controller 102 may execute a method 900 for managing memory access requests, which may be received from the host 750 or other source. The method 900 begins with block 902 in which the drive controller 102 determines whether a memory access request has been received. If so, the method 900 advances to block 904 in which the drive controller 102 determines whether the memory access request is a write request. If so, the method 900 advances to block 906 in which the drive controller 102 writes data included in the write request to the write buffer 302 of the non-volatile memory 110. In doing so, the drive controller 102 also updates the write count of the data in block 908. To do so, the drive controller 102 may update a write count of a band of physical memory or a LBA range associated with the data and stored in the memory context table 740. Additionally, in some embodiments, the drive controller 102 also invalidates older copies of the newly written data, which may be stored in the read cache 300 or the user data region 306, in block 910.

Subsequently, in block 912, the drive controller 102 determines whether the size of the write buffer has reached a threshold value. If so, the method 900 advances to block 914 in which the drive controller 102 evicts data from the write buffer 302 to reduce the size of the write buffer 302. To do so, the drive controller 102 determines which data to evict in block 916. The drive controller 102 may utilize any suitable methodology to determine the data to be evicted from the write buffer 302. For example, in some embodiments, the oldest data stored in the write buffer 302 is selected for eviction. In other embodiments, the data having the highest read count is selected for eviction. Of course, other parameters and criteria may be used in other embodiments to select the data for eviction from the write buffer 302. Once the data has been selected for eviction, the drive controller 102 may determine a new memory region of the non-volatile memory 110 to which the evicted data is to be moved in block 918. To do so, in the illustrative embodiment, the drive controller 102 may determine a read count associated with the data in block 920 and a write count associated with the data in block 922. The drive controller 102 may subsequently determine the new memory region for the evicted data based on the read-to-write count ratio (or the write-to-read count ratio) in block 924. For example, if the read-to-write count ratio is greater than a reference threshold value (e.g., the data is read much more than updated), the drive controller 102 may select the read cache 300 as the destination for the evicted data. However, if the read-to-write ratio is less than the reference threshold value, the drive controller 102 may select the user data region 306 as the destination for the evicted data. Regardless, in block 926, the drive controller 102 moves the evicted data from the write buffer 302 to the selected memory region. For example, in block 928, the drive controller 102 may move the evicted data from the write buffer 302 to the read cache 300 of the non-volatile memory 110. Alternatively, in block 930, the drive controller 102 may move the evicted data from the write buffer 302 to the user data region 306 of the non-volatile memory 110.

After the data has been evicted in block 914 or if no data eviction is required in block 912, the method 900 loops back to block 902 in which the drive controller 102 continues to monitor for memory access requests. Referring back to block 904, if a received memory access request is not a write request, the method 900 advances to block 932 in which the drive controller determines whether the memory access request is a read request. If so, the method 900 advances to block 934 in which the drive controller 102 determines the memory region of the requested data. To do so, if the memory request utilizes logical block addressing, the drive controller 102 may reference the logical-to-physical indirection table 742 to determine the physical location of the requested data. Subsequently, in block 936, the drive controller 102 reads the requested data from the determine memory region. For example, the drive controller 102 may read the requested data from the read cache 300 in block 938, from the write buffer 302 in block 940, or from the user data region 306 in block 942. Additionally, in block 944, the drive controller 102 may update the read count of the requested data. For example, the drive controller 102 may update the read count of a band of physical memory or a LBA range associated with the data and stored in the memory context table 740. Regardless, after the requested data has been retrieved, the method 900 loops back to block 902 in which the drive controller 102 continues to monitor for memory access requests.

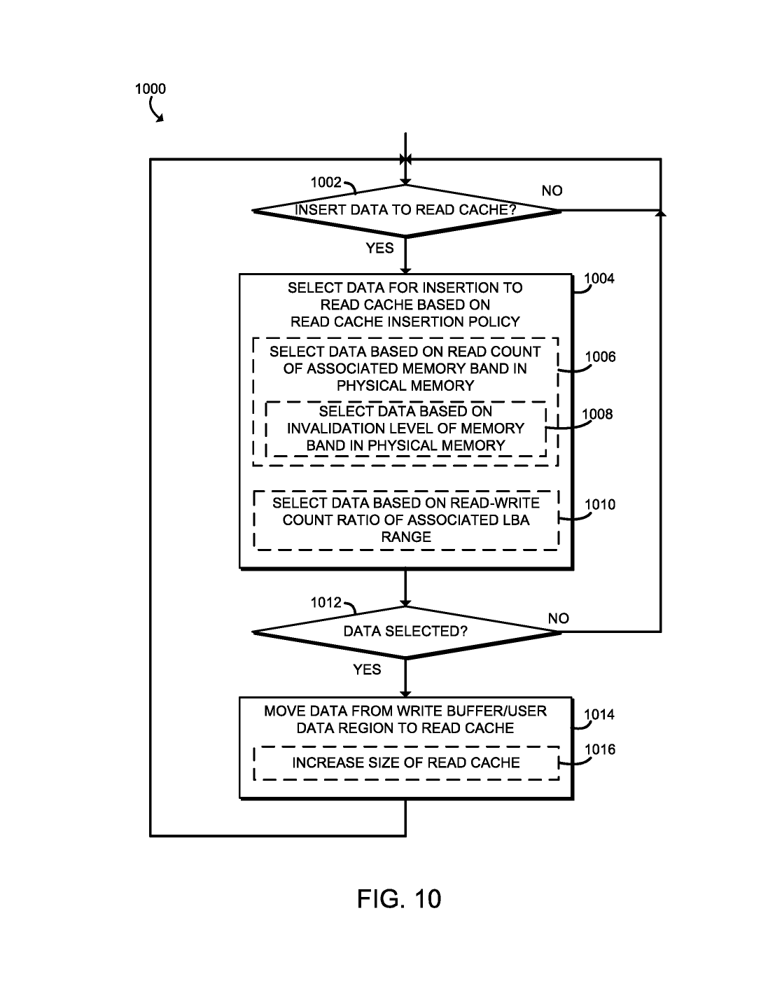

Referring now to FIG. 10, in use, the drive controller 102 may also execute a method 1000 for inserting data into the read cache 300 of the non-volatile memory 110. The method 1000 begins with block 1002 in which the drive controller 102 determines whether to insert data into the read cache 300. The drive controller 102 may determine to insert data into the read cache 300 based on any suitable criteria or parameter. For example, in some embodiments, the drive controller 102 is configured to insert additional data into the read cache 300 based on the present size of the read cache 300, the size of the unused space 304, and/or the size of the user data region 306. For example, if the size of the read cache 300 is determined to be below a reference threshold and the size of the unused space 304 is above a reference threshold, the drive controller 102 may determine to move data into the read cache 300. In other embodiments, the drive controller 102 may periodically check for data to be moved into the read cache 300.

If the drive controller 102 determines additional data is to be inserted into the read cache 300, the method 1000 advances to block 1004 in which the drive controller 102 selects the data to be moved into the read cache 300 based on a read count associated with the data and the read cache insertion policy 730. For example, the drive controller 102 may select data for insertion into the read cache 300 if the data has a read count above an insertion reference threshold identified in the read cache insertion policy 730. To do so, the drive controller 102 may analyze the data in physical memory or in logical memory. For example, in block 1006, the drive controller 102 may select data for insertion based on a read count of a memory band in physical memory associated with the data and select the data for insertion into the read cache 300 if the read count is greater than, or otherwise satisfies, the insertion reference threshold value. Additionally, in some embodiments in block 1008, the drive controller 102 may analyze the level of the level of invalidation of the memory band in determining whether to select the associated data for insertion into the read cache 300. In other embodiments, the drive controller 102 may select the data for insertion in to the read cache 300 based on a read count and a write count of a logical block addressed (LBA) range associated with the data in block 1010. To do so, the drive controller may determine whether the read count-to-write count ratio of the identified data is greater than, or otherwise satisfies, the insertion reference threshold value identified in the read cache insertion policy 730. Of course, the drive controller 102 may conversely analyze the write count-to-read count ratio to determine whether such ratio is below a reference threshold value.

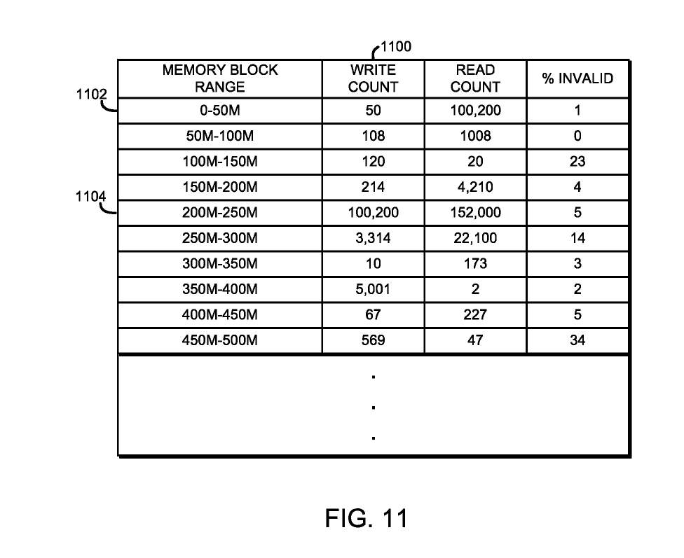

As discussed above, the read count, write count, and invalidation levels of the memory regions associated with the data may be stored in the memory context table 740. An illustrative logical memory context table 1100 is shown in FIG. 11. The table 1100 includes a number of rows; each assigned a corresponding LBA range. Each LBA range includes a corresponding write count, read count, invalidation level. As such, the drive controller 102 may be configured to analyze the memory context table 1100 to select the LBA range having the greatest read count-to-write count ratio. For example, the drive controller 102 may select the data of the LBA range 1102 for insertion into the read cache 300, even though the LBA range 1104 has a greater read count due to the large write count and associated lower read count-to-write count ratio of the LBA range 1104.

Referring back to FIG. 10, after the drive controller 102 has selected the data for insertion into the read cache 300, the method 1000 advances to block 1012. In block 1012, the drive controller 102 determines whether any data has been selected for insertion into the read cache 300. If not, the method 1000 loops back to block 1002 in which the drive controller 102 determines whether to insert additional data into the read cache 300. However, if data has been identified for insertion, the method 1000 advances to block 1014 in which the drive controller 102 moves the selected data into the read cache 300. For example, the drive controller 102 may move the selected data from the write buffer 302 or the user data region 306 into the read cache 300. If needed, the drive controller 102 may also increase the size of the read cache 300 in block 1016 if the usage characteristics of the non-volatile memory 110 allow (e.g., if the unused space 304 is greater than a minimum threshold value). The method 1000 subsequently loops back to block 1002 in which the drive controller 102 determines whether to insert additional data into the read cache 300.

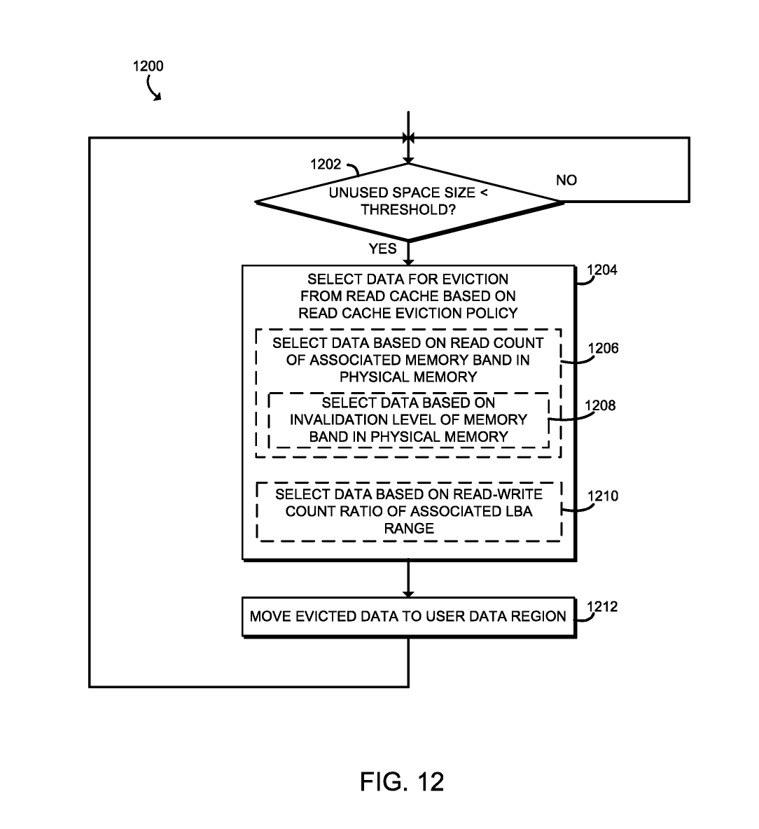

Referring now to FIG. 12, in use, the drive controller 102 may also execute a method 1200 for evicting data from the read cache 300 of the non-volatile memory 110. The method 1200 begins with block 1202 in which the drive controller 102 determines whether the unused space 304 of the non-volatile memory 110 is less than a reference threshold value, which may be stored in the read cache eviction policy 732. If so, the method 1200 advances to block 1204 in which the drive controller 102 select data for eviction from the read cache 300 based on a read count associated with the data and the read cache eviction policy 732. For example, the drive controller 102 may select data for eviction from the read cache 300 if the data has a read count below an eviction reference threshold value identified in the read cache eviction policy 732. To do so, the drive controller 102 may analyze the data in physical memory or in logical memory. For example, in block 1206, the drive controller 102 may select data for eviction based on a read count of a memory band in physical memory associated with the data and select the data for eviction from the read cache 300 if the read count is less than, or otherwise satisfies, the insertion eviction threshold value. Additionally, in some embodiments in block 1208, the drive controller 102 may analyze the level of invalidation of the memory band in determining whether to select the associated data for eviction from the read cache 300 (e.g., if the level of invalidation is relatively high). In other embodiments, the drive controller 102 may select the data for eviction from the read cache 300 based on a read count and a write count of a logical block addressed (LBA) range associated with the data in block 1210. To do so, the drive controller 102 may determine whether the read count-to-write count ratio of the identified data is less than, or otherwise satisfies, the eviction reference threshold value identified in the read cache eviction policy 732. Of course, the drive controller 102 may conversely analyze the write count-to-read count ratio to determine whether such ratio is greater a reference threshold value.

After the drive controller 102 has selected the data for eviction from the read cache 300, the method 1200 advances to block 1212 in which the drive controller moves the evicted data from the read cache 300 to the user data region 306. After the drive controller 102 has moved the evicted data from the read cache 300, the method 1200 loops back to block 1202 in which the drive controller 102 continues to monitor the size of the unused space 304 of the non-volatile memory 110.

### EXAMPLES

Illustrative examples of the technologies disclosed herein are provided below. An embodiment of the technologies may include any one or more, and any combination of, the examples described below.

Example 1 includes a solid state drive for managing a read cache, the solid state drive comprising a non-volatile memory having a write buffer, a read cache, and a user data region; and a drive controller configured to convert a memory region of the non-volatile memory corresponding to the read cache to a single-level cell (SLC) mode and manage data in the read cache based on a read count associated with the data.

Example 2 includes the subject matter of Example 1, and wherein to convert the memory region of the non-volatile memory comprises to convert the memory region of the non-volatile memory corresponding to the read cache from a triple-level cell (TLC) mode or a multi-level cell (MLC) mode to the SLC mode.

Example 3 includes the subject matter of any of Examples 1 and 2, and wherein to maintain the data in the read cache comprises to insert additional data from another region of the non-volatile memory into the read cache based on a read count associated with the additional data.

Example 4 includes the subject matter of any of Examples 1-3, and wherein to insert the additional data comprises to increase a size of the read cache of the non-volatile memory.

Example 5 includes the subject matter of any of Examples 1-4, and wherein to insert the additional data comprises insert the additional data from the another region of the non-volatile memory into the read cache in response to the read count associated with the additional data being greater than a reference threshold value.

Example 6 includes the subject matter of any of Examples 1-5, and wherein to insert the additional data comprises to determine a read count of a memory band of physical memory of non-volatile memory corresponding to the additional data; and move the additional data from the memory band to the read cache in response to the read count of the memory band being greater than a reference threshold value.

Example 7 includes the subject matter of any of Examples 1-6, and wherein the drive controller is further to determine a level of invalidation of the memory band, wherein to move the additional data comprises to move the additional data from the memory band to the read cache in response to (i) the read count of the memory band being greater than a read count reference threshold value and (ii) the level of invalidation of the memory band being less than an invalidation reference threshold value.

Example 8 includes the subject matter of any of Examples 1-7, and wherein to insert the additional data comprises to determine a read count of a logic block addressing (LBA) range of the non-volatile memory corresponding to the additional data; determine a write count of the LBA range of the non-volatile memory corresponding to the additional data; determine a read-write count ratio based on the read count and the write count of the LBA range of the non-volatile memory corresponding to the additional data; and move the additional data from the LBA range to the read cache in response to the read-write count ratio being greater than a reference threshold value.

Example 9 includes the subject matter of any of Examples 1-8, and wherein to maintain the data in the read cache comprises to evict selected data from the read cache based on a read count associated with the selected data.

Example 10 includes the subject matter of any of Examples 1-9, and wherein to evict the selected data from the read cache comprises to evict the selected data from the read cache in response to a size of an unused region of the non-volatile memory being less than a threshold size value.

Example 11 includes the subject matter of any of Examples 1-10, and wherein to evict the selected data from the read cache comprises to evict the selected data from the read cache in response to the read count associated with the selected data being less than a reference threshold value.

Example 12 includes the subject matter of any of Examples 1-11, and wherein evict the selected data comprises to determine a read count of a memory band of physical memory of non-volatile memory corresponding to the selected data; and move the selected data from the read cache in response to the read count of the memory band being less than a reference threshold value.

Example 13 includes the subject matter of any of Examples 1-12, and wherein the drive controller is further to determine a level of invalidation of the memory band, wherein to move the selected data comprises to move the selected data from the read cache in response to (i) the read count of the memory band being less than a read count reference threshold value or (ii) the level of invalidation of the memory band being greater than an invalidation reference threshold value.

Example 14 includes the subject matter of any of Examples 1-13, and wherein to evict the selected data comprises to determine a read count of a logic block addressing (LBA) range of the non-volatile memory corresponding to the selected data; determine a write count of the LBA range of the non-volatile memory corresponding to the selected data; determine a read-write count ratio based on the read count and the write count of the LBA range of the non-volatile memory corresponding to the selected data; and move the selected data from the LBA range in response to the read-write count ratio being less than a reference threshold value.

Example 15 includes the subject matter of any of Examples 1-14, and wherein to evict the selected data from the read cache comprises to move the selected data from the read cache to a user data region of the non-volatile memory based on a write count associated with the selected data.

Example 16 includes the subject matter of any of Examples 1-15, and wherein the drive controller is further to receive a memory read request for target data stored in the non-volatile memory; determine whether the target data is stored in the read cache; and direct the memory read request to the read cache in response to a determination that the target data is stored in the read cache.

Example 17 includes the subject matter of any of Examples 1-16, and wherein the drive controller is further to evict selected data from a write buffer of the non-volatile memory to the read cache based on a read count associated with the selected data.

Example 18 includes the subject matter of any of Examples 1-17, and wherein to evict the selected data from the write buffer comprises to determine a read count of the selected data; determine a write count of the selected data; determine a read-write count ratio based on the read count and the write count of the selected data; and move the selected data from the write buffer to the read cache in response to the read-write count ration being greater than a reference threshold value.

Example 19 includes a method for managing a read cache of a solid state drive, the method comprising establishing, by a drive controller of the solid state drive, a read cache in a non-volatile memory of the solid state drive, wherein establishing the read cache comprises converting a memory region of the non-volatile memory corresponding to the read cache to a single-level cell (SLC) mode; and maintaining, by the drive controller, data in the read cache based on a read count associated with the data.

Example 20 includes the subject matter of Example 19, and wherein converting the memory region of the non-volatile memory comprises converting the memory region of the non-volatile memory corresponding to the read cache from a triple-level cell (TLC) mode or a multi-level cell (MLC) mode to the SLC mode.

Example 21 includes the subject matter of any of Examples 19 and 20, and wherein maintaining the data in the read cache comprises inserting additional data from another region of the non-volatile memory into the read cache based on a read count associated with the additional data.

Example 22 includes the subject matter of any of Examples 19-21, and wherein inserting the additional data comprises increasing a size of the read cache of the non-volatile memory.

Example 23 includes the subject matter of any of Examples 19-22, and wherein inserting the additional data comprises inserting the additional data from the another region of the non-volatile memory into the read cache in response to the read count associated with the additional data being greater than a reference threshold value.

Example 24 includes the subject matter of any of Examples 19-23, and wherein inserting the additional data comprises determining a read count of a memory band of physical memory of non-volatile memory corresponding to the additional data; and moving the additional data from the memory band to the read cache in response to the read count of the memory band being greater than a reference threshold value.

Example 25 includes the subject matter of any of Examples 19-24, and further including determining a level of invalidation of the memory band, wherein moving the additional data comprises moving the additional data from the memory band to the read cache in response to (i) the read count of the memory band being greater than a read count reference threshold value and (ii) the level of invalidation of the memory band being less than an invalidation reference threshold value.

Example 26 includes the subject matter of any of Examples 19-25, and wherein inserting the additional data comprises determining a read count of a logic block addressing (LBA) range of the non-volatile memory corresponding to the additional data; determining a write count of the LBA range of the non-volatile memory corresponding to the additional data; determining a read-write count ratio based on the read count and the write count of the LBA range of the non-volatile memory corresponding to the additional data; and moving the additional data from the LBA range to the read cache in response to the read-write count ratio being greater than a reference threshold value.

Example 27 includes the subject matter of any of Examples 19-26, and wherein maintaining the data in the read cache comprises evicting selected data from the read cache based on a read count associated with the selected data.

Example 28 includes the subject matter of any of Examples 19-27, and wherein evicting the selected data from the read cache comprises evicting the selected data from the read cache in response to a size of an unused region of the non-volatile memory being less than a threshold size value.

Example 29 includes the subject matter of any of Examples 19-28, and wherein evicting the selected data from the read cache comprises evicting the selected data from the read cache in response to the read count associated with the selected data being less than a reference threshold value.

Example 30 includes the subject matter of any of Examples 19-29, and wherein evicting the selected data comprises determining a read count of a memory band of physical memory of non-volatile memory corresponding to the selected data; and moving the selected data from the read cache in response to the read count of the memory band being less than a reference threshold value.

Example 31 includes the subject matter of any of Examples 19-30, and further including determining a level of invalidation of the memory band, wherein moving the selected data comprises moving the selected data from the read cache in response to (i) the read count of the memory band being less than a read count reference threshold value or (ii) the level of invalidation of the memory band being greater than an invalidation reference threshold value.

Example 32 includes the subject matter of any of Examples 19-31, and wherein evicting the selected data comprises determining a read count of a logic block addressing (LBA) range of the non-volatile memory corresponding to the selected data; determining a write count of the LBA range of the non-volatile memory corresponding to the selected data; determining a read-write count ratio based on the read count and the write count of the LBA range of the non-volatile memory corresponding to the selected data; and moving the selected data from the LBA range in response to the read-write count ratio being less than a reference threshold value.

Example 33 includes the subject matter of any of Examples 19-32, and wherein evicting the selected data from the read cache comprises moving the selected data from the read cache to a user data region of the non-volatile memory based on a write count associated with the selected data.

Example 34 includes the subject matter of any of Examples 19-33, and further including receiving, by the drive controller, a memory read request for target data stored in the non-volatile memory; determining, by the drive controller, whether the target data is stored in the read cache; and directing, by the drive controller, the memory read request to the read cache in response to a determination that the target data is stored in the read cache.

Example 35 includes the subject matter of any of Examples 19-34, and further including evicting, by the drive controller, selected data from a write buffer of the non-volatile memory to the read cache based on a read count associated with the selected data.

Example 36 includes the subject matter of any of Examples 19-35, and wherein evicting the selected data from the write buffer comprises determining a read count of the selected data; determining a write count of the selected data; determining a read-write count ratio based on the read count and the write count of the selected data; and moving the selected data from the write buffer to the read cache in response to the read-write count ration being greater than a reference threshold value.

Example 37 includes one or more machine-readable storage media comprising a plurality of instructions stored thereon that, when executed, cause a solid state drive to perform the method of any of Examples 19-36.

Example 38 includes a solid state drive for managing a read cache, the solid state drive comprising a non-volatile memory having a write buffer and a user data region; and a drive controller configured to convert a portion of the non-volatile memory corresponding to a read cache from the user data region to a region having a higher memory access speed and memory endurance than the user data region.

Example 39 includes the subject matter of Example 38, and wherein the drive controller is further to increase the size of the read cache by converting additional regions of the non-volatile memory to the region having a higher memory access speed and memory endurance than the user data region based on a present size of the user data region.

Example 40 includes the subject matter of any of Examples 38 and 39, and wherein the drive controller is further to insert additional data from another region of the non-volatile memory into the read cache based on a read count associated with the additional data.

Example 41 includes the subject matter of any of Examples 38-40, and wherein the drive controller is further to evict selected data from the read cache based on a read count associated with the selected data.

Example 42 includes the subject matter of any of Examples 38-41, and wherein to evict the selected data from the read cache comprises to move the selected data from the read cache to a user data region of the non-volatile memory based on a write count associated with the selected data.

Example 43 includes the subject matter of any of Examples 38-42, and wherein the drive controller is further to receive a memory read request for target data stored in the non-volatile memory; determine whether the target data is stored in the read cache; and direct the memory read request to the read cache in response to a determination that the target data is stored in the read cache.

Example 44 includes the subject matter of any of Examples 38-43, and wherein the drive controller is further to evict selected data from a write buffer of the non-volatile memory to the read cache based on a read count associated with the selected data.

Example 45 includes a solid state drive for managing a read cache, the solid state drive comprising means for establishing a read cache in a non-volatile memory of the solid state drive, wherein establishing the read cache comprises converting a memory region of the non-volatile memory corresponding to the read cache to a single-level cell (SLC) mode; and means for managing data in the read cache based on a read count associated with the data.

Example 46 includes the subject matter of Example 45, and wherein the means for converting the memory region of the non-volatile memory comprises means for converting the memory region of the non-volatile memory corresponding to the read cache from a triple-level cell (TLC) mode or a multi-level cell (MLC) mode to the SLC mode.

Example 47 includes the subject matter of any of Examples 45 and 46, and wherein the means for managing the data in the read cache comprises means for inserting additional data from another region of the non-volatile memory into the read cache based on a read count associated with the additional data.

Example 48 includes the subject matter of any of Examples 45-47, and wherein the means for inserting the additional data comprises means for increasing a size of the read cache of the non-volatile memory.

Example 49 includes the subject matter of any of Examples 45-48, and wherein the means for inserting the additional data comprises means for inserting the additional data from the another region of the non-volatile memory into the read cache in response to the read count associated with the additional data being greater than a reference threshold value.

Example 50 includes the subject matter of any of Examples 45-49, and wherein the means for inserting the additional data comprises means for determining a read count of a memory band of physical memory of non-volatile memory corresponding to the additional data; and means for moving the additional data from the memory band to the read cache in response to the read count of the memory band being greater than a reference threshold value.

Example 51 includes the subject matter of any of Examples 45-50, and further including means for determining a level of invalidation of the memory band, wherein the means for moving the additional data comprises means for moving the additional data from the memory band to the read cache in response to (i) the read count of the memory band being greater than a read count reference threshold value and (ii) the level of invalidation of the memory band being less than an invalidation reference threshold value.

Example 52 includes the subject matter of any of Examples 45-51, and wherein the means for inserting the additional data comprises means for determining a read count of a logic block addressing (LBA) range of the non-volatile memory corresponding to the additional data; means for determining a write count of the LBA range of the non-volatile memory corresponding to the additional data; means for determining a read-write count ratio based on the read count and the write count of the LBA range of the non-volatile memory corresponding to the additional data; and means for moving the additional data from the LBA range to the read cache in response to the read-write count ratio being greater than a reference threshold value.

Example 53 includes the subject matter of any of Examples 45-52, and wherein the means for managing the data in the read cache comprises means for evicting selected data from the read cache based on a read count associated with the selected data.

Example 54 includes the subject matter of any of Examples 45-53, and wherein the means for evicting the selected data from the read cache comprises means for evicting the selected data from the read cache in response to a size of an unused region of the non-volatile memory being less than a threshold size value.

Example 55 includes the subject matter of any of Examples 45-54, and wherein the means for evicting the selected data from the read cache comprises means for evicting the selected data from the read cache in response to the read count associated with the selected data being less than a reference threshold value.

Example 56 includes the subject matter of any of Examples 45-55, and wherein the means for evicting the selected data comprises means for determining a read count of a memory band of physical memory of non-volatile memory corresponding to the selected data; and means for moving the selected data from the read cache in response to the read count of the memory band being less than a reference threshold value.

Example 57 includes the subject matter of any of Examples 45-56, and further including means for determining a level of invalidation of the memory band, wherein the means for moving the selected data comprises means for moving the selected data from the read cache in response to (i) the read count of the memory band being less than a read count reference threshold value or (ii) the level of invalidation of the memory band being greater than an invalidation reference threshold value.

Example 58 includes the subject matter of any of Examples 45-57, and wherein the means for evicting the selected data comprises means for determining a read count of a logic block addressing (LBA) range of the non-volatile memory corresponding to the selected data; means for determining a write count of the LBA range of the non-volatile memory corresponding to the selected data; means for determining a read-write count ratio based on the read count and the write count of the LBA range of the non-volatile memory corresponding to the selected data; and means for moving the selected data from the LBA range in response to the read-write count ratio being less than a reference threshold value.

Example 59 includes the subject matter of any of Examples 45-58, and wherein the means for evicting the selected data from the read cache comprises means for moving the selected data from the read cache to a user data region of the non-volatile memory based on a write count associated with the selected data.

Example 60 includes the subject matter of any of Examples 45-59, and further including means for receiving a memory read request for target data stored in the non-volatile memory; means for determining whether the target data is stored in the read cache; and means for directing the memory read request to the read cache in response to a determination that the target data is stored in the read cache.

Example 61 includes the subject matter of any of Examples 45-60, and further including means for evicting selected data from a write buffer of the non-volatile memory to the read cache based on a read count associated with the selected data.

Example 62 includes the subject matter of any of Examples 45-61, and wherein the means for evicting the selected data from the write buffer comprises means for determining a read count of the selected data; means for determining a write count of the selected data; means for determining a read-write count ratio based on the read count and the write count of the selected data; and means for moving the selected data from the write buffer to the read cache in response to the read-write count ration being greater than a reference threshold value.

1. A solid state drive for managing a read cache, the solid state drive comprising:
a non-volatile memory having a write buffer, a read cache, and a user data region; and
a drive controller configured to convert a memory region of the non-volatile memory corresponding to the read cache to a single-level cell (SLC) mode and manage data in the read cache based on a read count associated with the data.

2. The solid state drive of claim 1, wherein to convert the memory region of the non-volatile memory comprises to convert the memory region of the non-volatile memory corresponding to the read cache from a triple-level cell (TLC) mode or a multi-level cell (MLC) mode to the SLC mode.

3. The solid state drive of claim 1, wherein to manage the data in the read cache comprises to insert additional data from another region of the non-volatile memory into the read cache based on a read count associated with the additional data.

4. The solid state drive of claim 3, wherein to insert the additional data comprises to increase a size of the read cache of the non-volatile memory.

5. The solid state drive of claim 3, wherein to insert the additional data comprises insert the additional data from the another region of the non-volatile memory into the read cache in response to the read count associated with the additional data being greater than a reference threshold value.

6. The solid state drive of claim 1, wherein to manage the data in the read cache comprises to evict selected data from the read cache based on a read count associated with the selected data.

7. The solid state drive of claim 6, wherein to evict the selected data from the read cache comprises to evict the selected data from the read cache in response to a size of an unused region of the non-volatile memory being less than a threshold size value.

8. The solid state drive of claim 6, wherein to evict the selected data from the read cache comprises to evict the selected data from the read cache in response to the read count associated with the selected data being less than a reference threshold value.

9. The solid state drive of claim 1, wherein the drive controller is further to evict selected data from a write buffer of the non-volatile memory to the read cache based on a read count associated with the selected data.

10. One or more machine-readable storage media comprising a plurality of instructions stored thereon that, when executed, cause a solid state drive to:
establish a read cache in a non-volatile memory of the solid state drive, wherein to establish the read cache comprises to convert a memory region of the non-volatile memory corresponding to the read cache to a single-level cell (SLC) mode; and
manage data in the read cache based on a read count associated with the data.

11. The one or more machine-readable storage media of claim 10, wherein to convert the memory region of the non-volatile memory comprises to convert the memory region of the non-volatile memory corresponding to the read cache from a triple-level cell (TLC) mode or a multi-level cell (MLC) mode to the SLC mode.

12. The one or more machine-readable storage media of claim 10, wherein to manage the data in the read cache comprises to insert additional data from another region of the non-volatile memory into the read cache based on a read count associated with the additional data.

13. The one or more machine-readable storage media of claim 12, wherein to insert the additional data comprises to increase a size of the read cache of the non-volatile memory.

14. The one or more machine-readable storage media of claim 12, wherein to insert the additional data comprises to insert the additional data from the another region of the non-volatile memory into the read cache in response to the read count associated with the additional data being greater than a reference threshold value.

15. The one or more machine-readable storage media of claim 10, wherein to manage the data in the read cache comprises to evict selected data from the read cache based on a read count associated with the selected data.

16. The one or more machine-readable storage media of claim 15, wherein to evict the selected data from the read cache comprises to evict the selected data from the read cache in response to a size of an unused region of the non-volatile memory being less than a threshold size value.

17. The one or more machine-readable storage media of claim 15, wherein to evict the selected data from the read cache comprises to evict the selected data from the read cache in response to the read count associated with the selected data being less than a reference threshold value.

18. A method for managing a read cache of a solid state drive, the method comprising:
establishing, by a drive controller of the solid state drive, a read cache in a non-volatile memory of the solid state drive, wherein establishing the read cache comprises converting a memory region of the non-volatile memory corresponding to the read cache to a single-level cell (SLC) mode; and
managing, by the drive controller, data in the read cache based on a read count associated with the data.

19. The method of claim 18, wherein converting the memory region of the non-volatile memory comprises converting the memory region of the non-volatile memory corresponding to the read cache from a triple-level cell (TLC) mode or a multi-level cell (MLC) mode to the SLC mode.

20. The method of claim 18, wherein managing the data in the read cache comprises inserting additional data from another region of the non-volatile memory into the read cache based on a read count associated with the additional data.

21. The method of claim 20, wherein inserting the additional data comprises increasing a size of the read cache of the non-volatile memory.

22. The method of claim 20, wherein inserting the additional data comprises inserting the additional data from the another region of the non-volatile memory into the read cache in response to the read count associated with the additional data being greater than a reference threshold value.

23. The method of claim 18, wherein managing the data in the read cache comprises evicting selected data from the read cache based on a read count associated with the selected data.

24. The method of claim 23, wherein evicting the selected data from the read cache comprises evicting the selected data from the read cache in response to a size of an unused region of the non-volatile memory being less than a threshold size value.

25. The method of claim 23, wherein evicting the selected data from the read cache comprises evicting the selected data from the read cache in response to the read count associated with the selected data being less than a reference threshold value.
